(19) United States
(12) Patent Application Publication
(10) Pub. No.: US 2018/0036979 A1
(43) Pub. Date: Feb. 8, 2018

(54) COLOR MARK STRUCTURE APPLYING ON RUBBER PRODUCT AND METHOD FOR MAKING THE SAME

(71) Applicants: YU-JUI YANG, New Taipei (TW); Ju-Ying Yu, New Taipei (TW)

(72) Inventors: YU-JUI YANG, New Taipei (TW); Ju-Ying Yu, New Taipei (TW)

(21) Appl. No.: 15/788,819

(22) Filed: Oct. 20, 2017

(51) Int. Cl. B29D 30/72

(52) U.S. Cl. CPC B29D 30/72; B60C 13/001

(57) ABSTRACT

A color mark structure applying on rubber product comprises cellophane and a transfer paper. The transfer paper is arranged on the cellophane and a predetermined color or a predetermined pattern with a predetermined color is printed thereon by screen printing. The transfer paper having the predetermined color or the predetermined pattern with the predetermined color and the cellophane are attached on the rubber product. The upper and lower sides of the transfer paper are respectively connected with the cellophane and the rubber product.

### FIELD OF THE INVENTION

The present invention relates to a color mark, and more particularly to a color mark structure applying on rubber product and method for making the same.

### BACKGROUND OF THE INVENTION

Because the vulcanized rubber is capable of flowing and strengthening, the mark unit with brand may be blurred when the general mark unit is attached/adhered on the rubber product. Therefore, the color mark unit attached/adhered on the tire (for cars, trucks, buses, and etc.) is hard to show the brand mark clearly.

The conventional method for making color mark may reference to TW patent no. 1242758. It disclosed a method and end product of color mark on tensile rubber products. The steps of the method comprises material drawing step (step A), coating step (step B), attaching step (step C), vulcanizing step (step D), adhering step (step E), and cutting step (step F). The vulcanized rubber or the compounding rubber which is not vulcanized is drawn to be the raw material. A color mark unit is attached on the raw material with an adhesive. And then, the color mark unit and the raw material are totally attached together after they are vulcanized. A paste is coated on the side of the raw material opposite to the color mark unit so as to attach a protective film. Therefore, the rubber product may show color mark with brand thereon.

According to above mentioned method, the protective film of the end product after being cut is peeled off so as to attach on the rubber tire, such as for bicycles, motorcycles, cars, trucks. After pressurizing and vulcanizing, the raw material and the rubber tire are become one piece. However, the position and the angle of the raw material relative to the rubber product after pressurizing and vulcanizing are not fine-tuned. If the error happens while vulcanizing, the tire which may be high price is scrapped so that the defect rate and the cost become higher.

In view of the foregoing circumstances, the inventor has invested a lot of time to study the relevant knowledge, compare the pros and cons, research and develop related products. After quite many expetireents and tests, the “color mark structure applying on rubber product” of this invention is eventually launched to improve the foregoing shortcomings, to meet the public use.

### SUMMARY OF THE INVENTION

An object of this invention is providing a color mark structure applying on rubber product. When the pattern shape is attached on the tire, the position and the angle of the pattern shape may be fine-tuned due to directly be adhered by the adhesive. Compared to the conventional method, the transfer paper and the cellophane are vulcanized first and then attached/adhered to the tire. It may not cause the high-price tire to be scrapped and further may lower the defect rate. Additional, the use of the adhesive may prevent the pattern shape from peeling off.

To achieve above objects, a color mark structure applying on rubber product may comprise a cellophane; and a transfer paper, arranged on the cellophane, and a predetermined color or a predetermined pattern with a predetermined color is printed thereon by screen printing; wherein the transfer paper having the predetermined color or the predetermined pattern with the predetermined color and the cellophane are attached on the rubber product, and the upper and lower sides of the transfer paper are respectively connected with the cellophane and the rubber product.

In some embodiments, a size of the transfer paper and the cellophane which are attached together is cut to fit a machining size of a vulcanizer for vulcanizing.

In some embodiments, the transfer paper and the cellophane which are attached together and vulcanized are cut according to a predetermined shape or the predetermined pattern to form a pattern shape by laser cutting or a cutting machine.

In some embodiments, the pattern shape is attached on a tire by an adhesive which at least includes Ethyl cyanoacrylate.

To achieve above objects, a method for making the color mark structure is disclosed. The steps of the method may comprise: step S1: arranging a transfer paper on a cellophane and printing a predetermined color or a predetermined pattern with a predetermined color thereon by screen printing; step S2: cutting a size of the transfer paper and the cellophane which are attached together to fit a machining size of a vulcanizer for vulcanizing; step S3: putting the transfer paper and the cellophane which are attached together on a rubber product and peeling off the cellophane; step S4: vulcanizing the transfer paper and the rubber product in a vulcanizer; step S5: cutting the transfer paper and the cellophane which are attached together and vulcanized according to a predetermined shape or the predetermined pattern to form the pattern shape which includes shapes and words by laser cutting or a cutting machine; and step S6: attaching the pattern shape on a tire by an adhesive which at least includes Ethyl cyanoacrylate.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is a perspective view of a color mark structure applying on rubber product of the present invention.

FIG. 2 is a partially exploded view of the color mark structure of the present invention.

FIG. 3 is a perspective view of peeling off a cellophane in FIG. 1.

FIG. 4 is a cross-sectional view of FIG. 1 along line A-A.

FIG. 5 is a plan view of the color mark structure applying on rubber product of the present invention.

FIG. 6 is a perspective view of the color mark structure while attaching on a tire after being cut.

FIG. 7 is a cross-sectional view of FIG. 6 along line B-B.

### DESCRIPTION OF THE PREFERRED EMBODIMENT

Referring now to the drawings where like characteristics and features among the various figures are denoted by like reference characters.

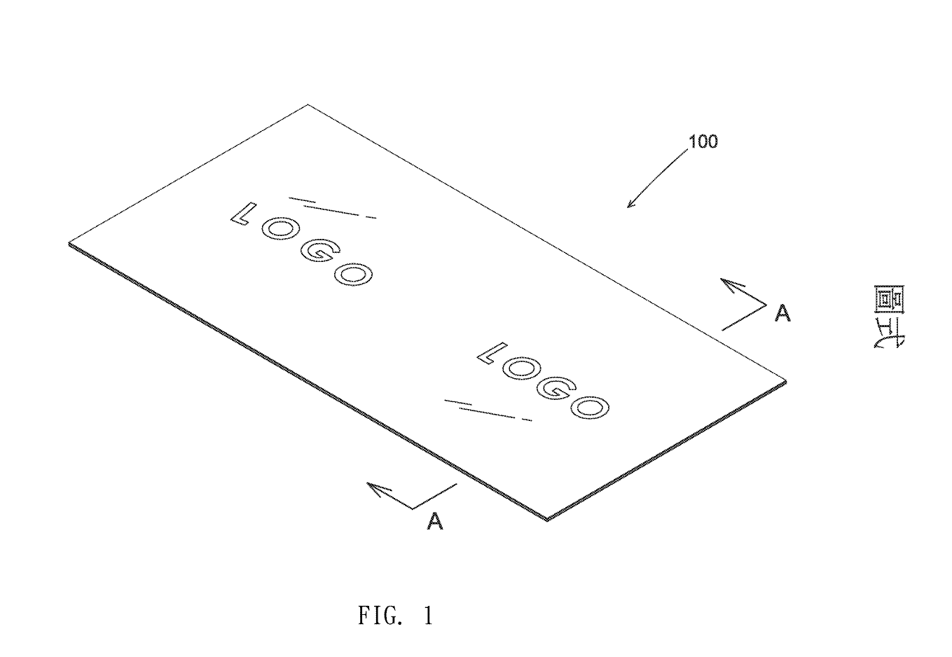

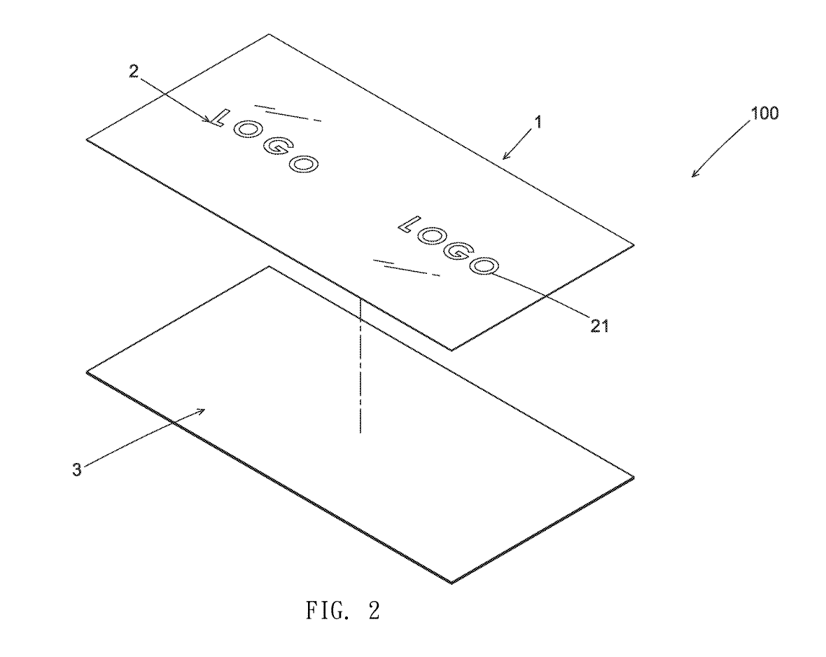

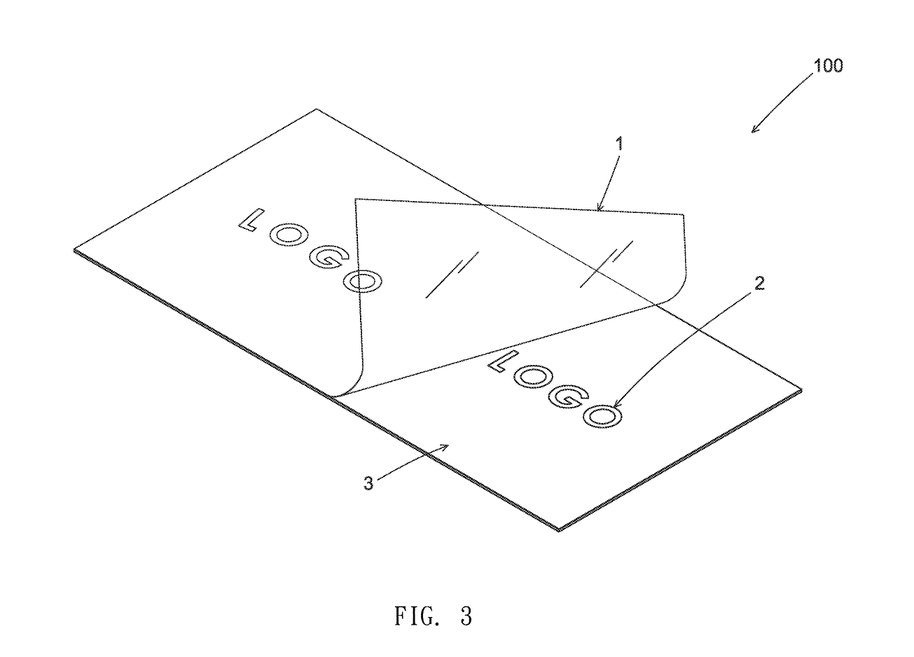

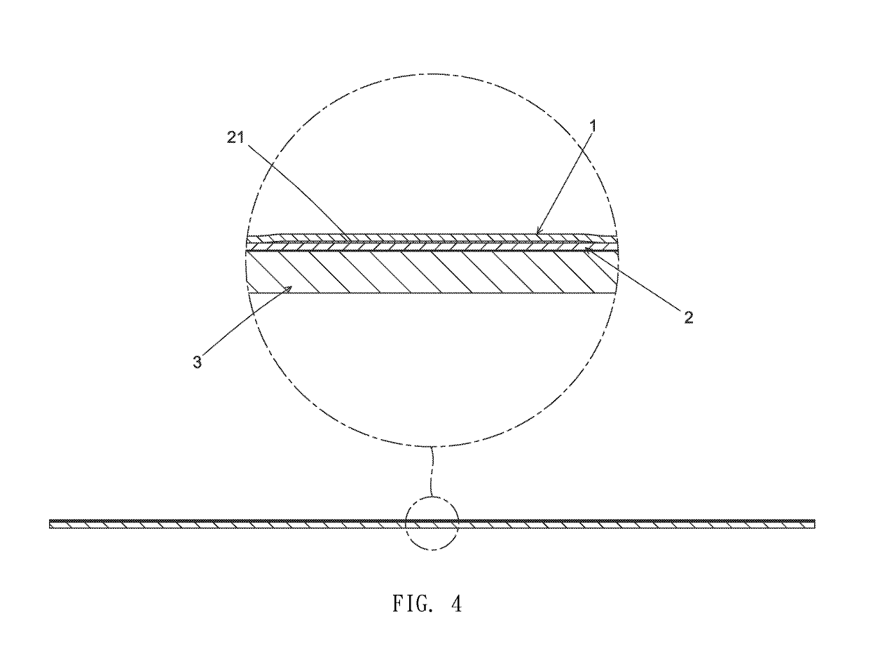

Please refer to FIGS. 1 to 7, a color mark structure 100 applying on rubber product 3 may comprise a cellophane 1, a transfer paper 2, and the rubber product 3.

The transfer paper 2 is arranged on the cellophane 1 and a predetermined color or a predetermined pattern with a predetermined color is printed thereon by screen printing.

The transfer paper 2 which has the predetermined color or the predetermined pattern with the predetermined color and the cellophane 1 are attached on the rubber product 3. That is, the upper and lower sides of the transfer paper 2 are respectively connected with the cellophane 1 and the rubber product 3.

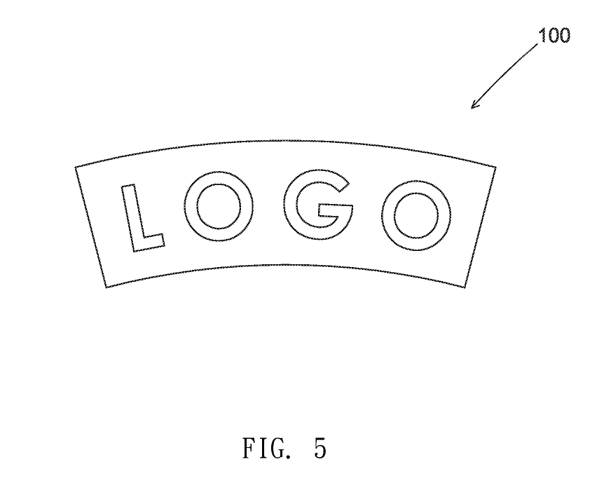

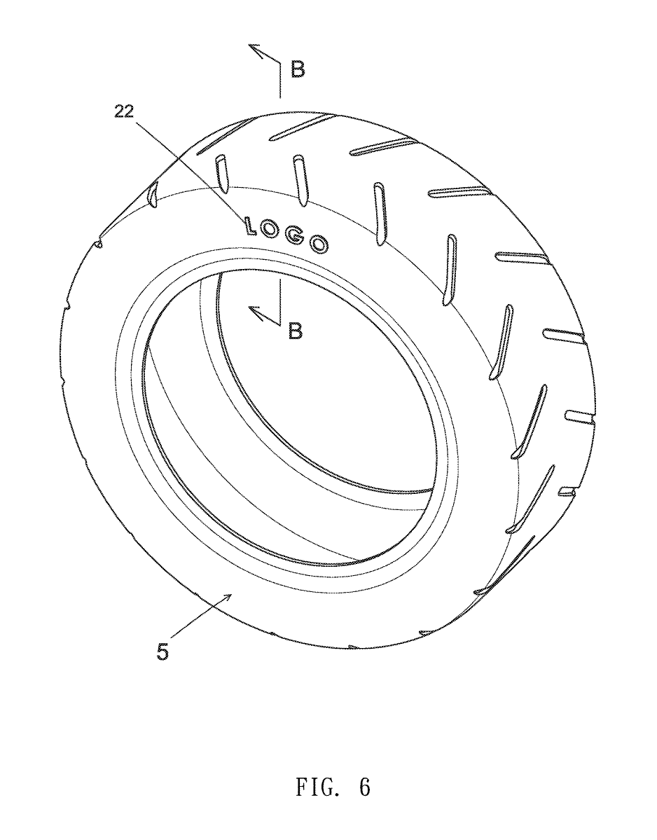

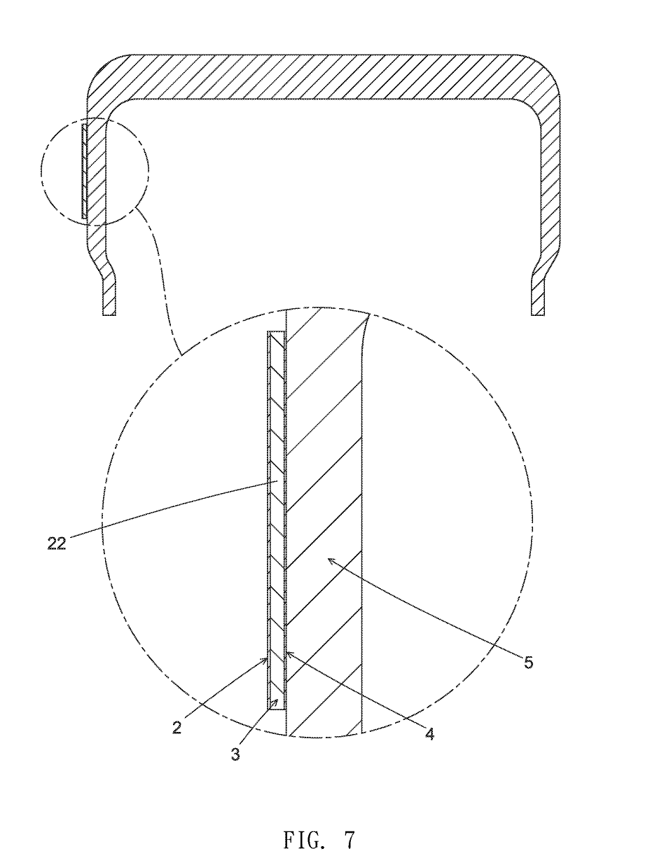

Please refer to FIG. 5, a size of the transfer paper 2 and the cellophane 1 which are attached together is cut to fit a machining size of a vulcanizer (not shown) for vulcanizing. Please refer to FIG. 6, the transfer paper 2 and the cellophane 1 which are attached together and vulcanized are cut according to a predetermined shape or the predetermined pattern to form a pattern shape 22 (“LOGO” in FIG. 6) by laser cutting or a cutting machine. And then, please refer to FIG. 7, the pattern shape 2 is attached on a tire 5 by an adhesive 4 which at least includes Ethyl cyanoacrylate.

Based on the above mentioned structure, the method for making the color mark structure 100 is described as follows.

Step SA1: arranging the transfer paper 2 on the cellophane 1 and printing a predetermined pattern with a predetermined color thereon by screen printing. Therefore, the cellophane 1 and the transfer paper 2 become one piece.

Step SA2: cutting a size of the transfer paper 2 and the cellophane 1 which are attached together to fit a machining size of the vulcanizer (not shown) for vulcanizing.

Step SA3: putting the transfer paper 2 with little stickiness and the cellophane 1 which are attached together on the rubber product 3 and peeling off the cellophane 1.

Step SA4: vulcanizing the transfer paper 2 and the rubber product 3 in a vulcanizer (not shown).

Step SA5: cutting the transfer paper 2 and the cellophane 1 which are attached together and vulcanized according to the predetermined pattern to form a pattern shape 22 which includes shapes and words by laser cutting or the cutting machine.

Step SA6: attaching the pattern shape 22 on a tire 5 by an adhesive 4 which at least includes Ethyl cyanoacrylate.

In another embodiment, the steps are described as follows.

Step SB1: arranging the transfer paper 2 on the cellophane 1 and printing a predetermined color thereon by screen printing. Therefore, the cellophane 1 and the transfer paper 2 become one piece. The predetermined color may be camouflage color.

Step SB2: cutting a size of the transfer paper 2 and the cellophane 1 which are attached together to fit a machining size of the vulcanizer (not shown) for vulcanizing.

Step SB3: putting the transfer paper 2 with little stickiness and the cellophane 1 which are attached together on the rubber product 3 and peeling off the cellophane 1.

Step SB4: vulcanizing the transfer paper 2 and the rubber product 3 in a vulcanizer (not shown).

Step SB5: cutting the transfer paper 2 and the cellophane 1 which are attached together and vulcanized according to a predetermined pattern to form a pattern shape 22 which includes shapes and words by laser cutting or the cutting machine. The predetermined pattern is set in the laser cut machine or the cutting machine.

Step SB6: attaching the pattern shape 22 on the tire 5 by the adhesive 4 which at least includes Ethyl cyanoacrylate.

The adhesive 4 which at least includes Ethyl cyanoacrylate is used for preventing from peeling off.

According to above structure and method, when the pattern shape 22 is attached on the tire 5, the position and the angle of the pattern shape 22 may be fine-tuned due to directly be adhered by the adhesive 4. Compared to the conventional method, the transfer paper and the cellophane 1 are vulcanized first and then attached/adhered to the tire 5. It may not cause the high-price tire to be scrapped and further may lower the defect rate. Additional, the use of the adhesive 4 may prevent the pattern shape 22 from peeling off.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. A color mark structure applying on rubber product, comprising:
a cellophane; and
a transfer paper, arranged on the cellophane, and a predetermined color or a predetermined pattern with a predetermined color is printed thereon by screen printing;
wherein the transfer paper having the predetermined color or the predetermined pattern with the predetermined color and the cellophane are attached on the rubber product, and the upper and lower sides of the transfer paper are respectively connected with the cellophane and the rubber product.

2. The color mark structure as claimed in claim 1, wherein a size of the transfer paper and the cellophane which are attached together is cut to fit a machining size of a vulcanizer for vulcanizing.

3. The color mark structure as claimed in claim 2, wherein the transfer paper and the cellophane which are attached together and vulcanized are cut according to a predetermined shape or the predetermined pattern to form a pattern shape by laser cutting or a cutting machine.

4. The color mark structure as claimed in claim 3, wherein the pattern shape is attached on a tire by an adhesive which at least includes Ethyl cyanoacrylate.

5. A method for making color mark structure, the steps comprising:
step S1: arranging a transfer paper on a cellophane and printing a predetermined color or a predetermined pattern with a predetermined color thereon by screen printing;
step S2: cutting a size of the transfer paper and the cellophane which are attached together to fit a machining size of a vulcanizer for vulcanizing;
step S3: putting the transfer paper and the cellophane which are attached together on a rubber product and peeling off the cellophane;
step S4: vulcanizing the transfer paper and the rubber product in a vulcanizer;
step S5: cutting the transfer paper and the cellophane which are attached together and vulcanized according to a predetermined shape or the predetermined pattern to form the pattern shape which includes shapes and words by laser cutting or a cutting machine; and
step S6: attaching the pattern shape on a tire by an adhesive which at least includes Ethyl cyanoacrylate.
